(19) United States
(12) Patent Application Publication
(10) Pub. No.: US 2007/0243488 A1
(43) Pub. Date: Oct. 18, 2007

(54) Resin composition

(76) Inventor: Hideyuki Tsunemori, Chiyoda-ku (JP)

Correspondence Address: WENDEROTH, LIND & PONACK, L.L.P., 2033 K STREET N. W., SUITE 800, WASHINGTON, DC, 20006-1021, US

(21) Appl. No.: 11/806,808

(22) Filed: Jun. 4, 2007

(30) Foreign Application Priority Data
Mar. 28, 2005 (JP) 2005-112069

(51) Int. Cl. G03C 1/00

(52) U.S. Cl. 430/270.1

(57) ABSTRACT

Provided is a resin composition that gives a molded article excellent in hardness and abrasion resistance and that is suitable for a photosensitive layer of an electrophotographic photoreceptor. This invention provides a resin composition containing an aromatic polycarbonate resin containing 90 to 100 mol% of a recurring unit from 1,1-bis(4-hydroxyphenyl)cyclohexane and a polyphenylene resin and also provides an electrophotographic photoreceptor using the above resin composition as a binder for a photosensitive layer.

### TECHNICAL FIELD

This invention relates to a resin composition containing an aromatic polycarbonate resin and a polyphenylene resin. More specifically, it relates to a resin composition suitable as a binder for a photosensitive layer of an electrophotographic photoreceptor. Further, it relates to an electrophotographic photoreceptor that uses the above resin composition and has excellent abrasion resistance.

### BACKGROUND ART

Having the characteristic features of high-speed printing and high print qualities, electrophotographic technologies are extensively employed in the fields of copying machines, laser beam printers, facsimile machines, and the like. As an electrophotographic photoreceptor for use with these electrophotographic technologies, there have been conventionally widely known photoreceptors that use inorganic photo conductive materials such as selenium, etc., while the mainstream of recent studies is in studies of electrophotographic photoreceptors that use organic photo conductive materials, which have advantages such as freedom from pollution, a cost and high productivity as compared with the above electrophotographic photoreceptors that use inorganic photo conductive materials.

The photosensitive layer surface of an electrophotographic photoreceptor directly receives electrical, thermal and mechanical outer forces from working processes, for example, of corona discharge, toner development, transfer, cleaning, etc., so that carrying out the electrophotographic process repeatedly involves the following problems. That is, there is a problem that the photosensitive layer surface is abraded or damaged due to insufficient durability against the mechanical outer force, which causes an image defect, and another problem is that low resistance materials such as ozone generated by corona discharge and nitrogen oxide, etc., generated from the ozone adhere to the photosensitive layer surface to be build up thereon, which adhering causes image deletion under a high-humidity environment.

Of these, the former problem of insufficient printing durability is particularly serious. That is, when the abrasion resistance of a photoreceptor is insufficient, the photoreceptor surface is abraded due to its frictions with a toner during the formation of a toner image and a paper sheet during the transfer of a toner on the photoreceptor to the paper sheet and its friction with a cleaning member, etc., during the removal of a remaining toner, and when the abrasion continues, normal printing or copying is no longer possible.

The above problem is greatly derived from the binder resin of the photoreceptor, and hence binder resin selection is very important. As a binder resin, conventionally, there have been proposed a methacrylic resin, an acrylic resin, polystyrene, polyester, polycarbonate, polyacrylate, polysulfone, etc., and mixtures of these.

Of these, a polycarbonate resin having excellent compatibility with a charge-transporting substance used in a photosensitive layer and also having excellent optical properties has been used as a binder resin for an organic electrophotographic photoreceptor. That is, the above polycarbonate resin has been selected from polycarbonate resins obtained from 2,2-bis(4-hydroxyphenyl)propane (bisphenol A), 1,1-bis(4-hydroxyphenyl)cyclohexane (bisphenol Z), etc., as raw materials (for example, see Patent Documents 1 and 2).

Given the present circumstances, however, these polycarbonate resins obtained from bisphenol A and bisphenol Z as raw materials are not yet satisfactory with regard to direct defects caused by the occurrence of abrasion or damage on the photosensitive layer surface, and it is desired to develop a binder resin capable of serving to form a photosensitive layer having high surface hardness.

As a resin having high hardness, a polyphenylene resin containing phenylene as a recurring unit is known (see Patent Document 3). However, this resin has a defect that it is poor in abrasion resistance in spite of its very high hardness.

(Patent Document 1) JP 60-172044A

(Patent Document 2) JP 63-170647A

(Patent Document 3) W093/18076

### DISCLOSURE OF THE INVENTION

It is an object of this invention to provide a resin composition that forms a molded article excellent in hardness and abrasion resistance.

It is another object of this invention to provide a resin composition suitable as a binder resin for a photosensitive layer of an electrophotographic photoreceptor.

It is further another object of this invention to provide an electrophotographic photoreceptor excellent in hardness and abrasion resistance.

The present inventor has studies for a resin composition that forms a molded article excellent in hardness and abrasion resistance. As a result, it has been found that a resin composition comprising an aromatic polycarbonate resin containing 90 to 100 mol % of a recurring unit from 1,1-bis(4-hydroxyphenyl)cyclohexane and a polyphenylene resin has excellent hardness and abrasion resistance and is excellent as a binder resin for a photosensitive layer, and this invention has been accordingly completed.

That is, this invention provides a resin composition comprising an aromatic polycarbonate resin (component A) and a polyphenylene resin (component B), the components A and B having a weight ratio (A/B) of 1/99 to 99/1,

the component A being an aromatic polycarbonate resin containing 90 to 100 mol % of a recurring unit represented by the following formula (A-1) and 10 to 0 mol % of a recurring unit represented by the following formula (A-2),

the component B being a polyphenylene resin containing 1 to 99 mol % of a recurring unit represented by the following formula (B-1) and 99 to 1 mol % of a recurring unit represented by the following formula (B-2). 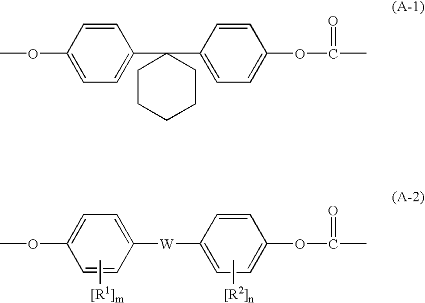
wherein each of R¹ and R² is independently a substituent selected from the group consisting of a hydrogen atom, a halogen atom, an alkyl group having 1 to 10 carbon atoms, an alkoxy group having 1 to 10 carbon atoms, a cycloalkyl group having 6 to 20 carbon atoms, a cycloalkoxy group having 6 to 20 carbon atoms, an aryl group having 6 to 10 carbon atoms, an aralkyl group having 7 to 20 carbon atoms, an aryloxy group having 6 to 10 carbon atoms and an aralkyloxy group having 7 to 20 carbon atoms, provided that when a plurality of R¹'s or a plurality of R²'s are present, R¹'s or R²'s may represent the same or different substituents, each of m and n is independently an integer of 1 to 4, and W is a structural unit represented by the following formula (A-3),

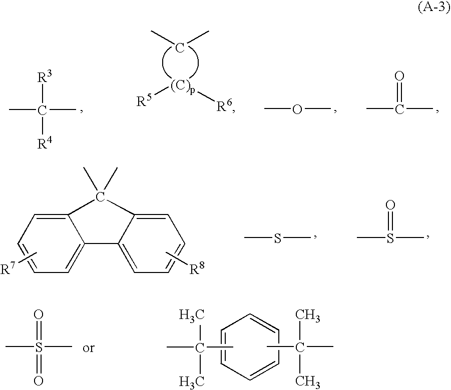

wherein each of R³ and R⁴ is independently a hydrogen atom or a hydrocarbon group having 1 to 10 carbon atoms, each of R⁵ and R⁶ is independently a hydrogen atom or an alkyl group having 1 to 3 carbon atoms, provided that when a plurality of R⁵'s or a plurality of R⁶'s are present, R⁵'s or R⁶'s may represent the same or different substituents, p is an integer of 4 to 12, each of R⁷ and R⁸ is independently a hydrogen atom, a halogen atom or an alkyl group having 1 to 3 carbon atoms,

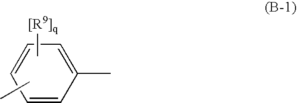

wherein the bonding position of the recurring unit is an ortho-, meta- or para-position, R⁹ is a substituent selected from the group consisting of a hydrogen atom, a halogen atom, an alkyl group having 1 to 10 carbon atoms, an alkoxy group having 1 to 10 carbon atoms, a cycloalkyl group having 6 to 20 carbon atoms, a cycloalkoxy group having 6 to 20 carbon atoms, an aryl group having 6 to 10 carbon atoms, an aralkyl group having 7 to 20 carbon atoms, an aryloxy group having 6 to 10 carbon atoms and an aralkyloxy group having 7 to 20 carbon atoms, provided that when a plurality of R⁹'s are present, R⁹'s represent the same or different substituents, and q is an integer of 1 to 4,

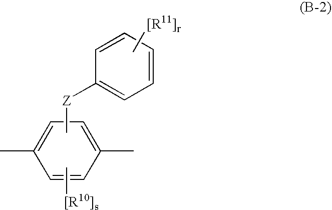

wherein each of R¹⁰ and R¹¹ is independently a substituent selected from the group consisting of a hydrogen atom, a halogen atom, an alkyl group having 1 to 10 carbon atoms, an alkoxy group having 1 to 10 carbon atoms, a cycloalkyl group having 6 to 20 carbon atoms, a cycloalkoxy group having 6 to 20 carbon atoms, an aryl group having 6 to 10 carbon atoms, an aralkyl group having 7 to 20 carbon atoms, an aryloxy group having 6 to 10 carbon atoms and an aralkyloxy group having 7 to 20 carbon atoms, provided that when a plurality of R¹⁰'s or a plurality of R¹¹'s are present, R¹⁰'s or R¹¹'s represent the same or different substituents, Z is O, S, O (COO), CO, SO, SO₂, CH₂, CF₂ or (CO)NH(CO) and each of r and s is independently an integer of 1 to 4.

Further, this invention is directed to a composition containing (i) the above resin composition, (ii) a charge-generating substance and/or a charge-transporting substance and (iii) an organic solvent.

Further, this invention provides an electrophotographic photoreceptor having an undercoat layer, a charge-generating layer and a charge-transporting layer stacked in this order on an electrically conductive substrate, the charge-transporting layer containing the above resin composition.

Further, this invention provides an electrophotographic photoreceptor having an undercoat layer and a charge-generating/transporting layer stacked in this order on an electrically conductive substrate, the charge-generating/transporting layer containing the resin composition recited in claim 1.

Further, this invention includes a copying machine having the above electrophotographic photoreceptor.

### BRIEF DESCRIPTION OF DRAWINGS

FIG. 1 is a schematic cross-sectional view of a negatively chargeable electrophotographic photoreceptor.

FIG. 2 is a schematic cross-sectional view of a positively chargeable electrophotographic photoreceptor.

### EXPLANATIONS OF LETTERS OR NOTATIONS

1 Charge-transporting layer (including a protective layer)
2 Charge-generating layer
3 Undercoat layer
4 Electrically conductive substrate
5 Charge-generating/transporting layer

### BEST MODE FOR EMBODIMENTS OF THE INVENTION

This invention will be explained in detail below.

<Resin Composition>

The resin composition of this invention contains an aromatic polycarbonate resin (component A) and a polyphenylene resin (component B).

The weight ratio (A/B) of the component A and the component B is 1/99 to 99/1, preferably 10/90 to 90/10, more preferably 20/80 to 80/20, still more preferably 30/70 to 70/30. When the weight ratio of the components A and B is brought into the above range, there can be obtained a binder resin composition excellent in surface hardness and abrasion resistance. When the ratio of the component B is smaller than 1 part by weight, the surface hardness and abrasion resistance are low. When the ratio of the component B is larger than 99 parts by weight, the binder resin composition is improved in surface hardness, while the surface is too hardened and hence the abrasion resistance is decreased.

(Aromatic Polycarbonate Resin: Component A)

The component A is an aromatic polycarbonate resin containing 90 to 100 mol % of a recurring unit represented by the following formula (A-1) and 10 to 0 mol % of a recurring unit represented by the following formula (A-2). The content of the recurring unit represented by the formula (A-1) is preferably 95 to 100 mol %, more preferably 98 to 100 mol %. The content of the recurring unit represented by the formula (A-2) is preferably 5 to 0 mol %, more preferably 2 to 0 mol %. The component A preferably contains 100 mol % of the recurring unit represented by the formula (A-1).

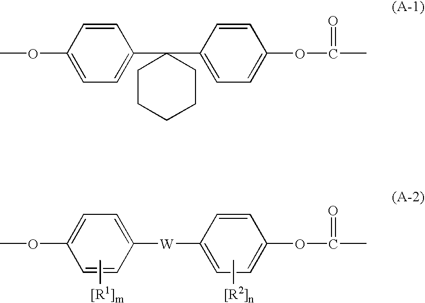

In the formula (A-2), each of R¹ and R² is independently a substituent selected from the group consisting of a hydrogen atom, a halogen atom, an alkyl group having 1 to 10 carbon atoms, an alkoxy group having 1 to 10 carbon atoms, a cycloalkyl group having 6 to 20 carbon atoms, a cycloalkoxy group having 6 to 20 carbon atoms, an aryl group having 6 to 10 carbon atoms, an aralkyl group having 7 to 20 carbon atoms, an aryloxy group having 6 to 10 carbon atoms and an aralkyloxy group having 7 to 20 carbon atoms. When a plurality of R¹'s or a plurality of R²'s are present, R¹'s or R²'s may represent the same or different substituents.

Regarding R¹ and R², the halogen atom includes a fluorine atom, a chlorine atom and a bromine atom, etc., the alkyl group having 1 to 10 carbon atoms includes methyl, ethyl, propyl, butyl, pentyl, hexyl, heptyl, octyl, nonyl, decyl, etc., the alkoxy group having 1 to 10 carbon atoms includes methoxy, ethoxy, propoxy, butoxy, etc., the cycloalkyl group having 6 to 20 carbon atoms includes cyclohexyl, cyclooctyl, etc., the cycloalkoxy group having 6 to 20 carbon atoms includes cyclohexyloxy, cyclooctoxy, etc., the aryl group having 6 to 10 carbon atoms includes phenyl, naphthyl, etc., the aralkyl group having 7 to 20 carbon atoms includes benzyl, phenethyl, etc., the aryloxy group having 6 to 10 carbon atoms includes phenoxy, etc., and the aralkyloxy group having 7 to 20 carbon atoms includes benzyloxy, etc.

Each of m and n is independently an integer of 1 to 4.

W is a structural unit of the following formula (A-3).

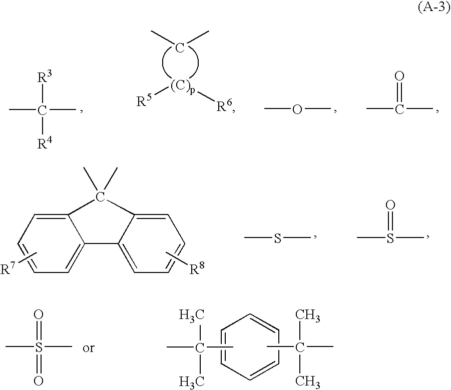

In the formula (A-3), each of R³ and R⁴ is independently a hydrogen atom or a hydrocarbon group having 1 to 10 carbon atoms. The hydrocarbon group having 1 to 10 carbon atoms includes an alkyl group having 1 to 10 carbon atoms and an alkoxy group having 1 to 10 carbon atoms. The alkyl group having 1 to 10 carbon atoms includes methyl, ethyl, propyl, butyl, pentyl, hexyl, heptyl, octyl, nonyl, decyl, etc. The alkoxy group having 1 to 10 carbon atoms includes methoxy, ethoxy, propoxy, butoxy, etc.

Each of R⁵ and R⁶ is independently a hydrogen atom or an alkyl group having 1 to 3 carbon atoms. When a plurality of R⁵'s or a plurality of R⁶'s are present, R⁵'s or R⁶'s may represent the same or different substituents. The alkyl group having 1 to 3 carbon atoms includes methyl, ethyl and propyl.

p is an integer of 4 to 12.

Each of R⁷ and R⁸ is independently a hydrogen atom, a halogen atom or an alkyl group having 1 to 3 carbon atoms. The halogen atom includes a fluorine atom, a chlorine atom, a bromine atom, etc. The alkyl group having 1 to 3 carbon atoms includes methyl, ethyl and propyl.

The recurring unit represented by the formula (A-2) is preferably a recurring unit derived from at least one member selected from 2,2-bis(4-hydroxyphenyl)propane, 1,1-bis(4-hydroxyphenyl)-3,3,5-trimethylcyclohexane, 4,4'-(m-phenyldiisopyridene)diphenol and 9,9-bis(4-hydroxy-3-methylphenyl)fluorene.

The recurring unit represented by the formula (A-2) is preferably a recurring unit represented by the following formula.

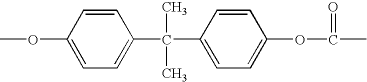

The component A preferably has a specific viscosity, measured in a solution of 0.7 g of the component A in 100 ml of methylene chloride at 20° C., of 0.2 to 1.5, preferably 0.3 to 1.2.

The component A is obtained by reacting a dihydric phenol with a carbonate precursor. Examples of the reaction method include an interfacial polymerization method, a melt ester exchange method, a solid-state ester exchange method of a carbonate prepolymer and a ring-opening polymerization method of a cyclic carbonate compound.

The dihydric phenol includes 1,1-bis(4-hydroxyphenyl)cyclohexane for forming the recurring unit represented by the formula (A-1) and 2,2-bis(4-hydroxyphenyl)propane, 1,1-bis(4-hydroxyphenyl)-3,3,5-trimethylcyclohexane, 4,4'-(m-phenyldiisopyridene)diphenol and 9,9-bis(4-hydroxy-3-methylphenyl)fluorene for forming the recurring unit represented by the formula (A-2).

As a carbonate precursor, a carbonyl halide, a carbonate diester or a haloformate is used, and specifically it includes phosgene, diphenyl carbonate and dihaloformate of a dihydric phenol.

The reaction by an interfacial polymerization method is generally a reaction between a dihydric phenol and phosgene, and they are allowed to react in the presence of an acid binder and an organic solvent. The acid binder is selected, for example, from alkali metal hydroxides such as sodium hydroxide and potassium hydroxide and pyridine. The organic solvent is selected, for example, from halogenated hydrocarbons such as methylene chloride, chlorobenzene and the like.

The reaction by a melt ester exchange method is generally an ester exchange reaction between a dihydric phenol and a carbonate diester, and the dihydric phenol and carbonate diester are mixed in the presence of an inert gas and the mixture is allowed to react under reduced pressure generally at 120 to 350° C. The pressure reduction degree is changed stepwise, and the pressure is finally reduced to 133 Pa or less to remove generated phenols out of the reaction system. The reaction time period is generally approximately 1 to 4 hours. The carbonate diester includes, for example, diphenyl carbonate, dinaphthyl carbonate, bis(diphenyl) carbonate, dimethyl carbonate, diethyl carbonate and dibutyl carbonate. Of these, diphenyl carbonate is preferred. A polymerization catalyst can be used for increasing the polymerization rate, and the polymerization catalyst includes hydroxides of alkali metals or alkaline earth metals such as sodium hydroxide, potassium hydroxide and the like.

(Polyphenylene Resin: Component B)

The component B is a polyphenylene resin containing 1 to 99 mol % of a recurring unit represented by the following formula (B-1) and 99 to 1 mol % of a recurring unit represented by the following formula (B-2). The content of the recurring unit represented by the formula (B-1) is preferably 5 to 95 mol %, more preferably 10 to 90 mol %. The content of the recurring unit represented by the formula (B-2) is preferably 95 to 5 mol %, more preferably 90 to 10 mol %. That is, preferably, the component B contains 10 to 90 mol % of the recurring unit represented by the formula (B-1) and 90 to 10 mol % of the recurring unit represented by the formula (B-2).

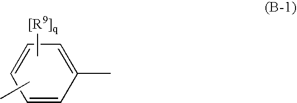

In the formula (B-1), the bonding position of the recurring unit is an ortho-, meta- or para-position. R⁹ is a substituent selected from the group consisting of a hydrogen atom, a halogen atom, an alkyl group having 1 to 10 carbon atoms, an alkoxy group having 1 to 10 carbon atoms, a cycloalkyl group having 6 to 20 carbon atoms, a cycloalkoxy group having 6 to 20 carbon atoms, an aryl group having 6 to 10 carbon atoms, an aralkyl group having 7 to 20 carbon atoms, an aryloxy group having 6 to 10 carbon atoms and an aralkyloxy group having 7 to 20 carbon atoms.

Regarding R⁹, the halogen atom includes a fluorine atom, a chlorine atom, a bromine atom, etc., the alkyl group having 1 to 10 carbon atoms includes methyl, ethyl, propyl, butyl, pentyl, hexyl, heptyl, octyl, nonyl, decyl, etc., the alkoxy group having 1 to 10 carbon atoms includes methoxy, ethoxy, propoxy, butoxy, etc., the cycloalkyl group having 6 to 20 carbon atoms includes cyclohexyl, cyclooctyl, etc., the cycloalkoxy group having 6 to 20 carbon atoms include cyclohexyloxy, cyclooctoxy, etc., the aryl group having 6 to 10 carbon atoms includes phenyl, naphthyl, etc., the aralkyl group having 7 to 20 carbon atoms includes benzyl, phenethyl, etc., the aryloxy group having 6 to 10 carbon atoms includes phenoxy, etc., and the aralkyloxy group having 7 to 20 carbon atoms includes benzyloxy, etc. q is an integer of 1 to 4.

In the polyphenylene resin, preferably, R⁹ in the recurring unit represented by the formula (B-1) is a substituent selected from the group consisting of a hydrogen atom, a halogen atom, an alkyl group having 1 to 3 carbon atoms, an alkoxy group having 1 to 3 carbon atoms, a cycloalkyl group having 6 to 8 carbon atoms, a cycloalkoxy group having 6 to 8 carbon atoms, an aryl group having 6 to 8 carbon atoms, an aralkyl group having 7 to 9 carbon atoms, an aryloxy group having 6 to 8 carbon atoms and an aralkyloxy group having 7 to 9 carbon atoms.

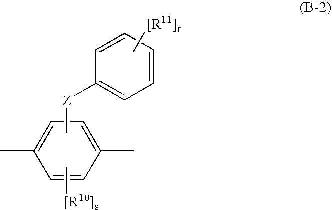

In the formula (B-2), each of R¹⁰ and R¹¹ is independently a substituent selected from the group consisting of a hydrogen atom, a halogen atom, an alkyl group having 1 to 10 carbon atoms, an alkoxy group having 1 to 10 carbon atoms, a cycloalkyl group having 6 to 20 carbon atoms, a cycloalkoxy group having 6 to 20 carbon atoms, an aryl group having 6 to 10 carbon atoms, an aralkyl group having 7 to 20 carbon atoms, an aryloxy group having 6 to 10 carbon atoms and an aralkyloxy group having 7 to 20 carbon atoms. When a plurality of R¹⁰'s or a plurality of R¹¹'s are present, R¹⁰'s or R¹¹'s represent the same or different substituents.

Regarding R¹⁰ and R¹¹, the halogen atom includes a fluorine atom, a chlorine atom and a bromine atom, etc., the alkyl group having 1 to 10 carbon atoms includes methyl, ethyl, propyl, butyl, pentyl, hexyl, heptyl, octyl, nonyl, decyl, etc., the alkoxy group having 1 to 10 carbon atoms includes methoxy, ethoxy, propoxy, butoxy, etc., the cycloalkyl group having 6 to 20 carbon atoms includes cyclohexyl, cyclooctyl, etc., the cycloalkoxy group having 6 to 20 carbon atoms includes cyclohexyloxy, cyclooctoxy, etc., the aryl group having 6 to 10 carbon atoms includes phenyl, naphthyl, etc., the aralkyl group having 7 to 20 carbon atoms includes benzyl, phenethyl, etc., the aryloxy group having 6 to 10 carbon atoms includes phenoxy, etc., and the aralkyloxy group having 7 to 20 carbon atoms includes benzyloxy, etc.

Z is O, S, O(COO), CO, SO, SO₂, CH₂, CF₂ or (CO)NH(CO). Each of r and s is independently an integer of 1 to 4.

Further, in the recurring unit represented by the formula (B-2), preferably, each of R¹⁰ and R¹¹ is independently a substituent selected from the group consisting of a hydrogen atom, a halogen atom, an alkyl group having 1 to 3 carbon atoms, an alkoxy group having 1 to 3 carbon atoms, a cycloalkyl group having 6 to 8 carbon atoms, a cycloalkoxy group having 6 to 8 carbon atoms, an aryl group having 6 to 8 carbon atoms, an aralkyl group having 7 to 9 carbon atoms, an aryloxy group having 6 to 8 carbon atoms and an aralkyloxy group having 7 to 9 carbon atoms.

Preferably, the recurring unit represented by the formula (B-1) is at least one recurring unit selected from the group consisting of 1,4-phenylene, 1,3-phenylene and 1,2-phenylene and the recurring unit represented by the formula (B-2) is at least one recurring unit selected from the group consisting of 1,4-benzoylphenylene and 1,4-(4'-phenoxybenzoylphenylene).

Preferably, the recurring unit represented by the formula (B-1) is 1,3-phenylene and the recurring unit represented by the formula (B-2) is 1,4-(benzoylphenylene).

The component B preferably has a specific viscosity, measured in a solution of 0.7 g of the component B in 100 ml of methylene chloride at 20° C., of 0.3 to 1.5, more preferably 0.3 to 1.2.

The polyphenylene resin (component B) can be produced from halogenated benzene, halogenated benzophenone, etc, as monomer components by addition polymerization. For example, it can be produced by the process described in International Publication No. W093/18076.

(Component C)

The resin composition of this invention may further contain 1 to 10 parts by weight, per 100 parts by weight of the component A, of an aromatic polycarbonate (component C) containing the recurring unit represented by the following formula.

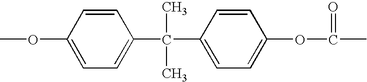

In the resin composition of this invention, the pencil hardness of a surface of the film formed therefrom is preferably 2H or higher, more preferably 3H or higher, still more preferably 4H or higher. Further, the Taber abrasion of a film formed from the resin composition of this invention is preferably 10.5 mg or less, more preferably 10.2 mg or less, still more preferably 10.0 mg or less. Further, the contact angle of a film formed from the resin composition of this invention is preferably 950° or more, more preferably 980° or more, still more preferably 100° or more. In the resin composition of this invention, further, the coefficient of static friction of a film formed therefrom is preferably 0.36 or less, more preferably 0.33 or less, still more preferably 0.30 or less. Further, the coefficient of kinetic fraction of a film formed therefrom is 0.26 or less, more preferably 0.23 or less, still more preferably 0.20 or less.

The resin composition of this invention preferably has a specific viscosity, measured in a solution of 0.7 g of the resin composition in 100 ml of methylene chloride at 20° C., of 0.2 to 1.5, more preferably 0.3 to 1.2.

The resin composition of this invention is suitable for a binder of photosensitive layer of an electrophotographic photoreceptor.

The resin composition of this invention can be produced, for example, by mixing the component B with the component A dissolved in a solvent and then removing the solvent. Further, it can be produced by mixing the component A with the component B with a super mixer, a tumbler, a Nauta-mixer or the like and palletizing the mixture with a twin-screw extruder or the like. Further, the resin composition may contain additives such as a stabilizer, an antioxidant, a photo stabilizer, a colorant, a lubricant, a release agent or the like as required. In any case, preferably, it is ensured that foreign matter and impurities in a raw material resin before the formation of a film are decreased such that the content thereof is as small as possible.

<Electrophotographic Photoreceptor>The electrophotographic photoreceptor of this invention comprises an electrically conductive substrate and a photosensitive layer that is formed thereon and that contains the resin composition of this invention.

The photosensitive layer can be formed from a composition containing (i) the resin composition of this invention, (ii) a charge-generating substance and/or a charge-transporting substance and (iii) an organic solvent by any method such as an immersion method, a spraying method, a roll method or the like.

The charge-generating substance is preferably an organic pigment or dye selected from phthalocyanine, squalylium, anthanthrone, perylene, azo, anthracene, pyrene, pyrithium and thiapyrylium pigments or dyes. The charge-generating substance preferably has an average particle diameter of 0.3 μm or less.

The charge-transporting substance includes, for example, heterocyclic compounds such as carbazole, indole, imidazole, thiazole, pyrazole, pyrazoline, etc., aniline derivatives, stilbene derivatives and electron-donating substances such as polymers having side chains formed of these compounds. In particular, a hydrazone derivative, a hydrazine derivative, an aniline derivative and a stilbene derivative are preferred.

The organic solvent is preferably at least one member selected from the group consisting of aromatic hydrocarbons such as benzene, xylene, toluene, ligroin, monochlorobenzene, dichlorobenzene, etc., ketones such as acetone, methyl ethyl ketone, cyclohexanone, etc., alcohols such as methanol, ethanol, isopropanol, etc., esters such as ethyl acetate, methyl cellosolve, etc., halogenated aliphatic hydrocarbons such as chloroform, ethylene chloride, methylene chloride, trichloroethylene, etc., ethers such as tetrahydrofuran, dioxane, ethylene glycol monomethyl ether, etc., amides such as N-methyl-2-pyrrolidone, N,N-dimethylformamide, N,N-dimethylacetamide, etc., and sulfoxides such as dimethyl sulfoxide, etc.

The amount of the charge-generating substance per 10 parts by weight of the resin composition of this invention is preferably 2 to 30 parts by weight. The amount of the charge-transporting substance per 10 parts by weight of the resin composition of this invention is preferably 0.5 to 5 parts by weight. The amount of the organic solvent per 10 parts by weight of the resin composition of this invention is preferably 20 to 100 parts by weight.

The electrophotographic photoreceptor of this invention is used in a copying machine or a printer. The electrophotographic photoreceptor of this invention includes a negatively chargeable type and a positively chargeable type.

(Negatively Chargeable Type)

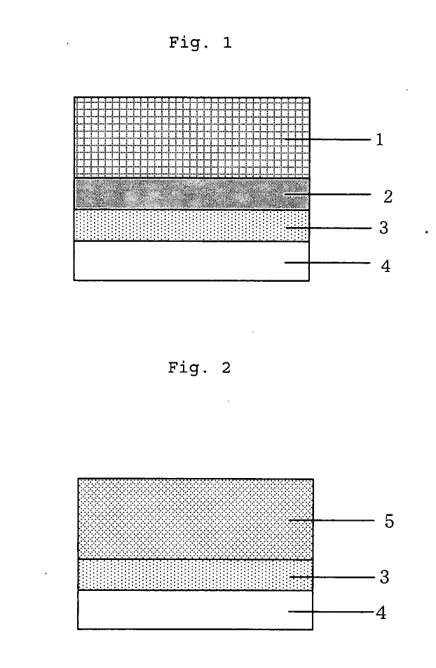

As shown in FIG. 1, the negatively chargeable electrophotographic photoreceptor is a stacked product in which an undercoat layer (3), a charge-generating layer (2) and a charge-transporting layer (1) are stacked in this order on an electrically conductive substrate (4), and the charge-transporting layer (1) contains the resin composition of this invention. Further, there is also included a negatively chargeable electrophotographic photoreceptor which further has a protective layer formed on the charge-transporting layer (1).

The electrically conductive substrate (4) is preferably an electrically conductive substrate formed of aluminum.

The charge-generating layer (2) contains the above charge-generating substance and a binder resin. Examples of the binder resin include polyvinyl butyral, polyvinyl acetal, a cellulose derivative, a phenolic resin and an epoxy resin. The amount of the charge-generating substance per 10 parts by weight of the binder resin is preferably 0.5 to 5 parts by weight.

The charge-generating layer (2) can be formed by pulverizing and dispersing the charge-generating substance in an organic solvent, adding the binder resin to prepare a composition and forming an approximately 0.05 to 5 μm thick of the composition on the electrically conductive substrate. The charge-generating layer (2) can be formed, for example, by the following manner. That is, there is prepared a composition containing a charge-generating substance such as a bisazo compound or the like, a polyvinyl butyral resin and a solvent such as dimethoxyethane. Then, an electrically conductive substrate such as an aluminum cylinder or the like is immersed in the thus-obtained composition, whereby a charge-generating layer can be formed. A binder resin layer may be formed between the electrically conductive substrate (4) and the charge-generating layer (2) instead of incorporating the binder resin into the composition.

The charge-transporting layer (1) contains the charge-transporting substance and the resin composition of this invention. Concerning the amount ratio of the charge-transporting substance and the resin composition of this invention in the charge-transporting layer (1), preferably, the amount of the charge-transporting substance per 10 parts by weight of the resin composition of this invention is 0.5 to 5 parts by weight. The thickness of the charge-transporting layer (1) is approximately 15 to 50 μm.

The material for the undercoat layer (3) is selected from polyamides such as nylon 6, nylon 66, nylon 11, nylon 610, a nylon copolymer, alkoxymethylated nylon, etc., casein, polyvinyl alcohol, nitrocellulose, an ethylene-acrylic acid copolymer, gelatin, polyurethane, polyvinyl butyral and metal oxides such as aluminum oxide, etc.

The charge-transporting layer (1) can be formed on the charge-generating layer (2) by preparing a solution containing the resin composition of this invention, the charge-transporting substance and an organic solvent and applying the solution by any method such as an immersion method, a spraying method, a roll method or the like. Specifically, the charge-transporting layer (1) can be formed by immersing a laminated product having the charge-generating layer (2) formed on the electrically conductive substrate (4) in a solution containing the charge-transporting substance such as a hydrazine compound, the resin composition of this invention and a solvent such as methylene chloride or the like. The organic solvent can be selected from aromatic hydrocarbons such as benzene, toluene, xylene, ligroin, monochlorobenzene, dichlorobenzene, etc., ketones such as acetone, methyl ethyl ketone, cyclohexanone, etc., alcohols such as methanol, ethanol, isopropanol, etc., esters such as ethyl acetate, methyl cellosolve, etc., halogenated aliphatic hydrocarbons such as chloroform, ethylene chloride, methylene chloride, trichloroethylene, etc., ethers such as tetrahydrofuran, dioxane, ethylene glycol monomethyl ether, etc., amides such as N-methyl-2-pyrrolidone, N,N-dimethylformamide, N,N-dimethylacetamide, etc., and sulfoxides such as dimethyl sulfoxide, etc.

A protective layer may be formed on the charge-transporting layer (1). The protective layer is preferably a layer formed of the resin composition of this invention. The thickness of the protective layer is preferably approximately 0.5 to 10 μm.

(Positively Chargeable Type)

As shown in FIG. 2, the positively chargeable electrophotographic photoreceptor is a stacked product in which an undercoat layer (3) and a charge-generating/transporting layer (5) are stacked in this order on an electrically conductive substrate (4). The charge-generating/transporting layer (5) contains the resin composition of this invention.

The electrically conductive substrate (4) is the same as that of the electrophotographic photoreceptor of the negative chargeable type.

The charge-generating/transporting layer (5) contains the charge-generating substance, the charge-transporting substance and, as a binder resin, the resin composition of this invention.

The charge-generating/transporting layer (5) may contain other binder resin. The “other binder resin” includes polymethyl methacrylate, a methyl methacrylate/styrene copolymer, polystyrene, polyester, polycarbonate, polyurethane and the like. The amount of the charge-generating substance per 10 parts by weight of the resin composition of this invention is preferably 2 to 30 parts by weight. The amount of the charge-transporting substance per 10 parts by weight of the resin composition of this invention is preferably 0.5 to 5 parts by weight. The thickness of the charge-generating/transporting layer (5) is approximately 15 to 50 μm.

The material for the undercoat layer (3) is selected from polyamides such as nylon 6, nylon 66, nylon 11, nylon 610, a nylon copolymer, alkoxymethylated nylon, etc., casein, polyvinyl alcohol, nitrocellulose, an ethylene-acrylic acid copolymer, gelatin, polyurethane, polyvinyl butyral and metal oxides such as aluminum oxide, etc.

The charge-generating/transporting layer (5) can be formed on the electrically conductive substrate (4) by preparing a solution containing the charge-generating substance, the charge-transporting substance, the resin composition of this invention and an organic solvent and applying the solution by any method such as an immersion method, a spraying method, a roll method or the like. The organic solvent can be selected from aromatic hydrocarbons such as benzene, toluene, xylene, ligroin, monochlorobenzene, dichlorobenzene, etc., ketones such as acetone, methyl ethyl ketone, cyclohexanone, etc., alcohols such as methanol, ethanol, isopropanol, etc., esters such as ethyl acetate, methyl cellosolve, etc., halogenated aliphatic hydrocarbons such as chloroform, ethylene chloride, methylene chloride, trichloroethylene, etc., ethers such as tetrahydrofuran, dioxane, ethylene glycol monomethyl ether, etc., amides such as N-methyl-2-pyrrolidone, N,N-dimethylformamide, N,N-dimethylacetamide, etc., and sulfoxides such as dimethyl sulfoxide, etc.

The surface hardness of the electrophotographic photoreceptor of this invention is preferably 2H or higher, more preferably 3H or higher, still more preferably 4H or higher. Further, when the electrophotographic photoreceptor of this invention is attached to a copying machine having a blade cleaning member, the surface abrasion (μm) of the electrophotographic photoreceptor after the use thereof for making 50,000 copies is preferably 2.5 μm or less, more preferably 1.5 μm or less, still more preferably 1.0 μm or less.

### EXAMPLES

This invention will be explained in detail with reference to Examples hereinafter, while it shall be in no way to be taken as limiting. In Examples and Comparative Examples, “part” stands for “part by weight”, and evaluations were carried out as follows.

(1) Glass Transition Temperature

Measured with a thermal analyzing system DSC-2910 supplied by TA Instruments Corporation in a nitrogen atmosphere (nitrogen flow rate: 40 ml/minute) under the condition of temperature-elevation rate of 20° C./minute.

(2) Specific Viscosity

0.7 Gram of a sample was dissolved in 100 ml of methylene chloride and the thus-prepared solution was measured for a specific viscosity (ηₛₚ) at 20° C.

(3) Pencil Hardness of Film

An obtained film was measured by a pencil scratch test according to JIS K 5400 (pencil: Mitsubishi Uni, pencil angle: 45 degrees, load: 1.0±0.05 kg).

(4) Abrasion Resistance of Film

A film was cut in the form of a disk having a diameter of 120 mm and evaluated for abrasion with a Taber abrader supplied by Toyo Seiki Seisaku-sho, Ltd. An atmosphere of 23° C. and 50% RH was employed as test conditions, and an abrasion was calculated from a difference between a weight that disk had before the test using a truck wheel CS-17 that rotated 2,000 times under a load of 500 gf (including a truck wheel weight) and a weight that the disk had after the above test.

(5) Pencil Hardness of Electrophotographic Photoreceptor

An obtained electrophotographic photoreceptor was measured by a pencil scratch test according to JIS K 5400 (pencil: Mitsubishi Uni, pencil angle: 45 degrees, load: 1.0±0.05 kg).

(6) Abrasion Resistance of Electrophotographic Photoreceptor and Image Defect

An obtained electrophotographic photoreceptor was attached to a copying machine having a blade cleaning member, 50,000 copies were made, and then the electrophotographic photoreceptor was evaluated for a surface abrasion (μm).

Further, copies were visually inspected to see whether or not image defects were caused by abrasion or scratches.

### Example 1

(Component A)

A reactor having a thermometer, a stirrer and a reflux condenser was charged with 1,963 parts of ion-exchanged water and 314 parts of a 48.5% sodium hydroxide aqueous solution, and 292 parts of 1,1-bis(4-hydroxyphenyl)cyclohexane (to be sometimes referred to as “BP-Z” hereinafter) and 0.61 part of hydrosulfite were dissolved therein. Then, 1,112 parts of methylene chloride was added, and 135 parts of phosgene was blown in with stirring at 22 to 30° C. over 60 minutes. After completion of the addition of the phosgene by blowing, 44 parts of a 48.5% sodium hydroxide aqueous solution and a solution of 155 parts of p-tert-butylphenol in 5 parts of methylene chloride were added, and the mixture was emulsified. Then, 0.3 part of triethylamine was added, and the mixture was stirred at 28 to 33° C. for 1 hour to complete the reaction. After completion of the reaction, a formed product was diluted with methylene chloride and washed with water, and it was acidified with hydrochloric acid and washed with water. When the electric conductivity of an aqueous phase came to be almost the same as that of ion-exchanged water, methylene chloride was distilled off to give a powder of a polycarbonate resin (component A) formed of 100 mol % of the recurring unit represented by the formula (A-1).

(Component B)

As a component B, a polyphenylene resin (Parmax-1201 Krum, supplied by Mississippi Polymer Technologies Inc.) was provided.

(Preparation of Dope)

The polycarbonate resin (component A) and the polyphenylene resin (component B) were dissolved in methylene chloride in a weight ratio (A/B) of 80/20 to prepare a dope having a solid concentration of 20% by weight.

(Formation of Film)

The dope was cast on a flat glass plate to form a cast film having an average thickness of 500 μm. The cast film was left at room temperature for 2 hours, at 40° C. for 3 hours and at 60° C. for 3 hours to remove the solvent, and it was dried at 120° C. for 24 hours to give a transparent film. The thus-obtained film was subjected to the pencil hardness test and the Taber abrasion test. Table 1 shows the results.

(Production of Electrophotographic Photoreceptor)

To 10 parts of a bisazo compound represented by the following formula (D-1) and 10 parts of a polyvinyl butyral resin was added 100 parts of dimethoxyethane, 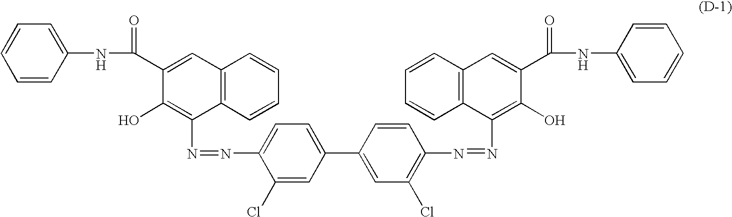
and they were pulverized and dispersed with a sand grindmill to prepare a dispersion. A planished aluminum cylinder having a diameter of 30 mm was immersed in the thus-obtained dispersion to form a 0.15 μm thick charge-generating layer on the aluminum cylinder surface.

The polycarbonate resin (component A) and the polyphenylene resin (component B) were mixed in a weight ratio shown in Table 1 to prepare a resin composition.

10 Parts of a hydrazine compound represented by the following formula (D-2) 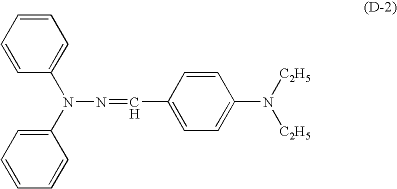
and 10 parts of the above-obtained resin composition (A/B=80/20) were dissolved in 55 parts of methylene chloride to prepare a dope. The aluminum cylinder having the charge-generating layer was immersed in the dope, and it was taken out and dried to give an electrophotographic photoreceptor having a 20 μm thick charge-transporting layer. The thus-obtained electrophotographic photoreceptor was evaluated for pencil hardness and abrasion resistance. Table 1 shows the results.

### Example 2

A resin composition, a film and an electrophotographic photoreceptor were obtained in the same manner as in Example 1 except that the weight ratio (A/B) of the components A and B was changed to 60/40. Table 1 shows results.

### Example 3

A resin composition, a film and an electrophotographic photoreceptor were obtained in the same manner as in Example 1 except that the weight ratio (A/B) of the components A and B was changed to 40/60. Table 1 shows results.

### Example 4

A resin composition, a film and an electrophotographic photoreceptor were obtained in the same manner as in Example 1 except that the weight ratio (A/B) of the components A and B was changed to 20/80. Table 1 shows results.

### Example 5

A resin composition, a film and an electrophotographic photoreceptor were obtained in the same manner as in Example 1 except that 292 parts of BP-Z was replaced with 263 parts of BP-Z and 25 parts of 2,2-bis(4-hydroxyphenyl)propane (BP-A). Table 2 shows results.

### Example 6

A resin composition, a film and an electrophotographic photoreceptor were obtained in the same manner as in Example 5 except that the weight ratio (A/B) of the components A and B was changed to 60/40. Table 2 shows results.

### Example 7

A resin composition, a film and an electrophotographic photoreceptor were obtained in the same manner as in Example 5 except that the weight ratio (A/B) of the components A and B was changed to 40/60. Table 2 shows results.

### Example 8

A resin composition, a film and an electrophotographic photoreceptor were obtained in the same manner as in Example 5 except that the weight ratio (A/B) of the components A and B was changed to 20/80. Table 2 shows results.

### Example 9

(Component C)

A reactor having a thermometer, a stirrer and a reflux condenser was charged with 1,963 parts of ion-exchanged water and 314 parts of a 48.5% sodium hydroxide aqueous solution, and 251 parts of BP-A and 0.61 part of hydrosulfite were dissolved therein. Then, 1,112 parts of methylene chloride was added, and 135 parts of phosgene was blown in with stirring at 22 to 30° C. over 60 minutes. After completion of the addition of the phosgene by blowing, 44 parts of a 48.5% sodium hydroxide aqueous solution and a solution of 155 parts of p-tert-butylphenol in 5 parts of methylene chloride were added, and the mixture was emulsified. Then, 0.3 part of triethylamine was added, and the mixture was stirred at 28 to 33° C. for 1 hour to complete the reaction. After completion of the reaction, a formed product was diluted with methylene chloride and washed with water, and it was acidified with hydrochloric acid and washed with water. When the electric conductivity of an aqueous phase came to be almost the same as that of ion-exchanged water, methylene chloride was distilled off to give a powder of a polycarbonate resin (component C) formed of 100 mol % of PC-A.

A resin composition, a film and an electrophotographic photoreceptor were obtained in the same manner as in Example 1 except that the polycarbonate resin (component A) having 100 mol % of the recurring unit represented by the formula (A-1), obtained in Example 1, the component B and the component C were used in a weight ratio (A/B/C) of 45/50/5. Table 2 shows results.

### Comparative Example 1

A polycarbonate resin (component A) was obtained in the same manner as in Example 1 except that 292 parts of BP-Z was replaced with 204 parts of BP-Z and 75 parts of BP-A. A resin composition, a film and an electrophotographic photoreceptor were obtained in the same manner as in Example 1 except that the thus-obtained component A (BP-Z/BP-A=70/30) was used in place. Table 3 shows results.

### Comparative Example 2

A resin composition, a film and an electrophotographic photoreceptor were obtained in the same manner as in Comparative Example 1 except that the weight ratio (A/B) of the components A and B was changed to 60/40. Table 3 shows results.

### Comparative Example 3

A resin composition, a film and an electrophotographic photoreceptor were obtained in the same manner as in Comparative Example 1 except that the weight ratio (A/B) of the components A and B was changed to 40/60. Table 3 shows results.

### Comparative Example 4

A resin composition, a film and an electrophotographic photoreceptor were obtained in the same manner as in Comparative Example 1 except that the weight ratio (A/B) of the components A and B was changed to 20/80. Table 3 shows results.

### Comparative Example 5

A resin, a film and an electrophotographic photoreceptor were obtained in the same manner as in Example 1 except that only the polycarbonate resin polymerized in Example 1 (component A: BP-Z/BP-A=100/0) was used. Table 3 shows the results.

### Comparative Example 6

A resin, a film and an electrophotographic photoreceptor were obtained in the same manner as in Example 1 except that only the polycarbonate resin polymerized in Example 5 (component A: BP-Z/BP-A=90/10) was used. Table 4 shows results.

### Comparative Example 7

A resin composition, a film and an electrophotographic photoreceptor were obtained in the same manner as in Example 1 except that only a polyphenylene resin (component B: Parmax-1201 Krum, supplied by Mississippi Polymer Technologies Inc.) was used. Table 4 shows the results.

### Comparative Example 8

A resin composition, a film and an electrophotographic photoreceptor were obtained in the same manner as in Example 1 except that only the polycarbonate resin polymerized in Example 9 (component C: BP-Z/BP-A=0/100) was used. Table 4 shows the results.

### Comparative Example 9

A resin composition, a film and an electrophotographic photoreceptor were obtained in the same manner as in Example 1 except that 292 parts of BP-Z was replaced with 251 parts of 2,2-bis(4-hydroxyphenyl)propane (BP-A) when a component A was polymerized. Table 5 shows results.

### Comparative Example 10

A resin composition, a film and an electrophotographic photoreceptor were obtained in the same manner as in Comparative Example 9 except that the weight ratio (A/B) of the components A and B was changed to 60/40. Table 5 shows results.

### Comparative Example 11

A resin composition, a film and an electrophotographic photoreceptor were obtained in the same manner as in Comparative Example 9 except that the weight ratio (A/B) of the components A and B was changed to 40/60. Table 5 shows results.

### Comparative Example 12

A resin composition, a film and an electrophotographic photoreceptor were obtained in the same manner as in Comparative Example 9 except that the weight ratio (A/B) of the components A and B was changed to 20/80. Table 5 shows the results.

TABLE 1

| | Component, | | | | | |
|---|---|---|---|---|---|---|
| | Properties | Unit | Example 1 | Example 2 | Example 3 | Example 4 |
| (Component A) | BP-Z | Mol % | 100 | 100 | 100 | 100 |
| | BP-A | Mol % | 0 | 0 | 0 | 0 |
| | Polycarbonate resin | Wt. % | 80 | 60 | 40 | 20 |
| (Component B) | Polyphenylene resin | Wt. % | 20 | 40 | 60 | 80 |
| (Component C) | Polycarbonate resin | Wt. % | 0 | 0 | 0 | 0 |
| Resin | Specific viscosity | — | 0.89 | 0.88 | 0.89 | 0.91 |
| composition | Glass transition | ° C. | 167 | 163 | 159 | 154 |
| | temperature | | | | | |
| Pencil | Film | — | 2H | 2H | 3H | 4H |
| hardness | EPP* | | 2H | 2H | 3H | 4H |
| Abrasion | Film | mg | 9.1 | 8.2 | 7.8 | 8.8 |
| resistance | EPP* | μg | 1.4 | 0.9 | 1.0 | 1.3 |
| Electro- | Image defect | Yes/ | No | No | No | No |
| photographic | | No | | | | |
| photoreceptor | | | | | | |

*EPP = Electrophotographic photoreceptor

TABLE 2

| | Component, | | | | | | |
|---|---|---|---|---|---|---|---|
| | Properties | Unit | Example 5 | Example 6 | Example 7 | Example 8 | Example 9 |
| (Component A) | BP-Z | Mol % | 90 | 90 | 90 | 90 | 100 |
| | BP-A | Mol % | 10 | 10 | 10 | 10 | 0 |
| | Polycarbonate resin | Wt. % | 80 | 60 | 40 | 20 | 45 |
| (Component B) | Polyphenylene resin | Wt. % | 20 | 40 | 60 | 80 | 50 |
| (Component C) | Polycarbonate resin | Wt. % | 0 | 0 | 0 | 0 | 5 |
| Resin | Specific viscosity | — | 0.88 | 0.87 | 0.89 | 0.93 | 0.87 |
| composition | Glass transition | ° C. | 165 | 161 | 157 | 153 | 160 |
| | temperature | | | | | | |
| Pencil | Film | — | 2H | 2H | 3H | 4H | 2H |
| hardness | EPP* | | 2H | 2H | 3H | 4H | 2H |
| Abrasion | Film | mg | 9.3 | 8.5 | 8.1 | 9.0 | 8.4 |
| resistance | EPP* | μg | 1.7 | 1.1 | 1.4 | 1.5 | 0.9 |
| Electro- | Image defect | Yes/No | No | No | No | No | No |
| photographic | | | | | | | |
| photoreceptor | | | | | | | |

*EPP = Electrophotographic photoreceptor

TABLE 3

| | Component, Properties | Unit | CEx. 1 | CEx. 2 | CEx. 3 | CEx. 4 | CEx. 5 |
|---|---|---|---|---|---|---|---|
| (Component A) | BP-Z | Mol % | 70 | 70 | 70 | 70 | 100 |
| | BP-A | Mol % | 30 | 30 | 30 | 30 | 0 |
| | Polycarbonate resin | Wt. % | 80 | 60 | 40 | 20 | 100 |
| (Component B) | Polyphenylene resin | Wt. % | 20 | 40 | 60 | 80 | 0 |
| (Component C) | Polycarbonate resin | Wt. % | 0 | 0 | 0 | 0 | 0 |
| Resin | Specific viscosity | — | 0.88 | 0.85 | 0.86 | 0.89 | 0.89 |
| composition | Glass transition | ° C. | 159 | 154 | 150 | 146 | 170 |
| | temperature | | | | | | |
| Pencil | Film | — | B | HB | HB | H | H |
| hardness | EPP* | | B | HB | HB | H | H |
| Abrasion | Film | mg | 16.4 | 15.3 | 15.1 | 14.8 | 13.4 |
| resistance | EPP* | μg | 6.2 | 4.8 | 4.2 | 3.8 | 3.1 |
| Electro- | Image defect | Yes/No | Yes | Yes | Yes | Yes | Yes |
| photographic | | | | | | | |
| photoreceptor | | | | | | | |

*EPP = Electrophotographic photoreceptor
CEx. = Comparative Example

TABLE 4

| | Component, | | | | |
|---|---|---|---|---|---|
| | Properties | Unit | CEx. 6 | CEx. 7 | CEx. 8 |
| (Component A) | BP-Z | Mol % | 90 | 0 | 0 |
| | BP-A | Mol % | 10 | 0 | 0 |
| | Polycarbonate | Wt. % | 100 | 0 | 0 |
| | resin | | | | |
| (Component B) | Polyphenylene | Wt. % | 0 | 100 | 0 |
| | resin | | | | |
| (Component C) | Polycarbonate | Wt. % | 0 | 0 | 100 |
| | resin | | | | |
| Resin | Specific viscosity | — | 0.88 | 1.10 | 0.85 |
| composition | Glass transition | ° C. | 167 | 150 | 145 |
| | temperature | | | | |
| Pencil | Film | — | H | 6 H | 3 B |
| hardness | EPP* | | H | 6 H | 3 B |
| Abrasion | Film | mg | 14.4 | 11.6 | 19.6 |
| resistance | EPP* | μg | 3.8 | 3.6 | 8.7 |
| Electro- | Image defect | Yes/No | Yes | Yes | Yes |
| photographic | | | | | |
| photoreceptor | | | | | |

*EPP = Electrophotographic photoreceptor
CEx. = Comparative Example

TABLE 5

| | Component, Properties | Unit | CEx. 9 | CEx. 10 | CEx. 11 | CEx. 12 |
|---|---|---|---|---|---|---|
| (Component A) | BP-Z | Mol % | 0 | 0 | 0 | 0 |
| | BP-A | Mol % | 100 | 100 | 100 | 100 |
| | Polycarbonate resin | Wt. % | 80 | 60 | 40 | 20 |
| (Component B) | Polyphenylene resin | Wt. % | 20 | 40 | 60 | 80 |
| (Component C) | Polycarbonate resin | Wt. % | 0 | 0 | 0 | 0 |
| Resin | Specific viscosity | — | 0.85 | 0.84 | 0.84 | 0.89 |
| composition | Glass transition temperature | ° C. | 151 | 150 | 151 | 150 |
| Pencil | Film | — | 3B | 2B | HB | HB |
| hardness | EPP* | | 3B | 2B | HB | HB |
| Abrasion | Film | mg | 17.6 | 15.5 | 15.3 | 16.8 |
| resistance | EPP* | μg | 6.6 | 5.3 | 4.9 | 6.4 |
| Electro- | Image defect | Yes/No | Yes | Yes | Yes | Yes |
| photographic | | | | | | |
| photoreceptor | | | | | | |

*EPP = Electrophotographic photoreceptor
CEx. = Comparative Example

### Effect of the Invention

A molded article obtained from the resin composition of this invention is excellent in hardness and abrasion resistance. The resin composition of this invention is therefore can be suitably used as a binder resin for a photosensitive layer of an electrophotographic photoreceptor which photosensitive layer is required to have hardness and abrasion resistance. The electrophotographic photoreceptor of this invention is excellent in hardness and abrasion resistance.

### INDUSTRIAL UTILITY

Having excellent abrasion resistance, the electrophotographic photoreceptor containing the resin composition of this invention can be applied to a copying machine, a laser beam printer, a facsimile machine, and the like.

1. A resin composition comprising an aromatic polycarbonate resin (component A) and a polyphenylene resin (component B), the components A and B having a weight ratio (A/B) of 1/99 to 99/1,
the component A being an aromatic polycarbonate resin containing 90 to 100 mol % of a recurring unit represented by the following formula (A-1) and 10 to 0 mol % of a recurring unit represented by the following formula (A-2),
the component B being a polyphenylene resin containing 1 to 99 mol % of a recurring unit represented by the following formula (B-1) and 99 to 1 mol % of a recurring unit represented by the following formula (B-2), 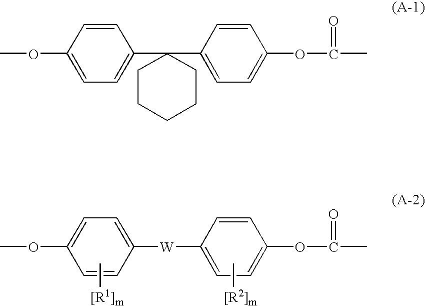
wherein each of R¹ and R² is independently a substituent selected from the group consisting of a hydrogen atom, a halogen atom, an alkyl group having 1 to 10 carbon atoms, an alkoxy group having 1 to 10 carbon atoms, a cycloalkyl group having 6 to 20 carbon atoms, a cycloalkoxy group having 6 to 20 carbon atoms, an aryl group having 6 to 10 carbon atoms, an aralkyl group having 7 to 20 carbon atoms, an aryloxy group having 6 to 10 carbon atoms and an aralkyloxy group having 7 to 20 carbon atoms, provided that when a plurality of R¹'s or a plurality of R²'s are present, R¹'s or R²'s may represent the same or different substituents, each of m and n is independently an integer of 1 to 4, and W is a structural unit represented by the following formula (A-3), 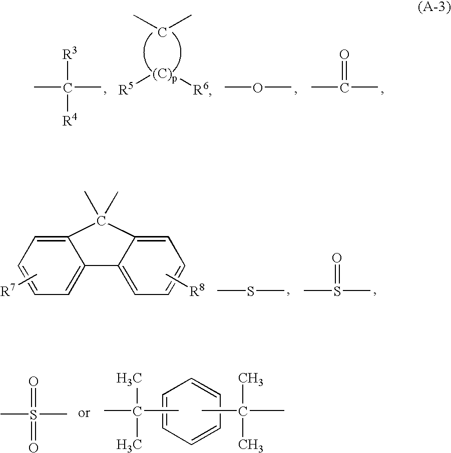
wherein each of R³ and R⁴ is independently a hydrogen atom or a hydrocarbon group having 1 to 10 carbon atoms, each of R⁵ and R⁶ is independently a hydrogen atom or an alkyl group having 1 to 3 carbon atoms, provided that when a plurality of R⁵'s or a plurality of R⁶'s are present, R⁵'s or R⁶'s may represent the same or different substituents, p is an integer of 4 to 12, each of R⁷ and R⁸ is independently a hydrogen atom, a halogen atom or an alkyl group having 1 to 3 carbon atoms, 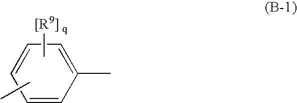
wherein the bonding position of the recurring unit is an ortho-, meta- or para-position, R⁹ is a substituent selected from the group consisting of a hydrogen atom, a halogen atom, an alkyl group having 1 to 10 carbon atoms, an alkoxy group having 1 to 10 carbon atoms, a cycloalkyl group having 6 to 20 carbon atoms, a cycloalkoxy group having 6 to 20 carbon atoms, an aryl group having 6 to 10 carbon atoms, an aralkyl group having 7 to 20 carbon atoms, an aryloxy group having 6 to 10 carbon atoms and an aralkyloxy group having 7 to 20 carbon atoms, provided that when a plurality of R⁹'s are present, R⁹'s represent the same or different substituents, and q is an integer of 1 to 4, provided that when a plurality of R⁹'s are present, R⁹'s represent the same or different substituents, and q is an integer of 1 to 4, 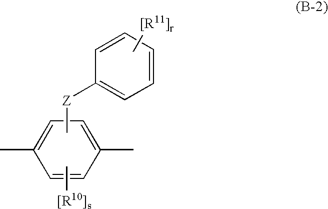
wherein each of R¹⁰ and R¹¹ is independently a substituent selected from the group consisting of a hydrogen atom, a halogen atom, an alkyl group having 1 to 10 carbon atoms, an alkoxy group having 1 to 10 carbon atoms, a cycloalkyl group having 6 to 20 carbon atoms, a cycloalkoxy group having 6 to 20 carbon atoms, an aryl group having 6 to 10 carbon atoms, an aralkyl group having 7 to 20 carbon atoms, an aryloxy group having 6 to 10 carbon atoms and an aralkyloxy group having 7 to 20 carbon atoms, provided that when a plurality of R¹⁰'s or a plurality of R¹¹'s are present, R¹⁰'s or R¹¹'s represent the same or different substituents, Z is O, S, O(COO), Co, SO, SO₂, CH₂, CF₂ or (CO)NH(CO) and each of r and s is independently an integer of 1 to 4.

2. The resin composition of claim 1, wherein the recurring unit represented by the formula (A-2) is a recurring unit derived from at least one member selected from 2,2-bis(4-hydroxyphenyl)propane, 1,1-bis(4-hydroxyphenyl)-3,3,5-trimethylcyclohexane, 4,4'-(m-phenyldiisopyridene)diphenol and 9,9-bis(4-hydroxy-3-methylphenyl)fluorene.

3. The resin composition of claim 1, wherein the recurring unit represented by the formula (A-2) is

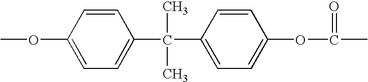

4. The resin composition of claim 1, wherein the component A contains 100 mol % of the recurring unit represented by the formula (A-1).

5. The resin composition of claim 1, wherein the component A has a specific viscosity, measured in a solution of 0.7 g of the component A in 100 ml of methylene chloride at 20° C., of 0.2 to 1.5.

6. The resin composition of claim 1, which has a specific viscosity, measured in a solution of 0.7 g of the resin composition in 100 ml of methylene chloride at 20° C., of 0.2 to 1.5.

7. The resin composition of claim 1, wherein the recurring unit of the formula (B-1) is at least one recurring unit selected from the group consisting of 1,4-phenylene, 1,3-phenylene and 1,2-phenylene and the recurring unit of the formula (B-2) is at least one recurring unit selected from the group consisting of 1,4-benzoylphenylene and 1,4-(4'-phenoxybenzoylphenylene).

8. The resin composition of claim 1, wherein the component A and the component B have a weight ratio (A/B) of from 20/80 to 80/20.

9. The resin composition of claim 1, wherein the component B contains 10 to 90 mol % of the recurring unit represented by the formula (B-1) and 90 to 10 mol % of the recurring unit represented by the formula (B-2).

10. The resin composition of claim 1, which contains 1 to 10 parts by weight, per 100 parts by weight of the component A, of an aromatic polycarbonate (component C) containing a recurring unit represented by the following formula,

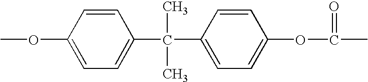

11. The resin composition of claim 1, which is for use as a binder in photosensitive layer of an electrophotographic photoreceptor.

12. A composition comprising (i) the resin composition recited in claim 1, (ii) a charge-generating substance and/or a charge-transporting substance and (iii) an organic solvent.

13. The composition of claim 12, wherein the charge-generating substance is an organic pigment or dye selected from phthalocyanine, squalylium, anthanthrone, perylene, azo, anthracene, pyrene, pyrithium and thiapyrylium organic pigments or dyes.

14. The composition of claim 12, wherein the charge-transporting substance is at least one member selected from the group consisting of a hydrazine derivative, a hydrazone derivative, an aniline derivative and a stilbene derivative.

15. The resin composition of claim 12, wherein the organic solvent is at least one member selected from the group consisting of tetrahydrofuran, toluene, chlorobenzene, methylene chloride and N-methyl-2-pyrrolidone.

16. An electrophotographic photoreceptor comprising an undercoat layer, a charge-generating layer, a charge-transporting layer and an electrically conductive substrate, and these layers are arranged in this order, wherein the charge-transporting layer containing the resin composition recited in claim 1.

17. An electrophotographic photoreceptor comprising an undercoat layer, a charge-generating-transporting layer and an electrically conductive substrate, and these layers are arranged in this order, wherein the charge-generating-transporting layer containing the resin composition recited in claim 1.

18. The electrophotographic photoreceptor of claim 16, which has a surface having a pencil hardness of 2H or higher.

19. A copying machine having the electrophotographic photoreceptor recited in claim 16.

20. The electrophotographic photoreceptor of claim 17, which has a surface having a pencil hardness of 2H or higher.

21. A copying machine having the electrophotographic photoreceptor recited in claim 17.
